(19) United States
(12) Patent Application Publication
(10) Pub. No.: US 2005/0121137 A1
(43) Pub. Date: Jun. 9, 2005

(54) Joint designs for laser welding of thermoplastics

(76) Inventor: Thomas R. Kirkland, Elburn, IL (US)

Correspondence Address: JENKENS & GILCHRIST, P.C., 225 WEST WASHINGTON, SUITE 2600, CHICAGO, IL, 60606, US

(21) Appl. No.: 11/003,872

(22) Filed: Dec. 3, 2004

Related U.S. Application Data
(60) Provisional application No. 60/527,595, filed on Dec. 5, 2003.
(60) Provisional application No. 60/545,057, filed on Feb. 17, 2004.

(51) Int. Cl. B32B 31/00; B32B 31/24

(52) U.S. Cl. 156/272.8; 156/379.8

(57) ABSTRACT

A welding system includes a pair of thermoplastic components forming a weld interface extending at an acute angle to the direction of application of a clamping force. A clamping mechanism applies a clamping force to the two components to urge the components together at said weld interface, and laser light is directed onto the weld interface to weld the two components together.

### FIELD OF THE INVENTION

This invention is directed generally to laser welding of thermoplastic materials, and, more particularly, to a system for laser welding thermoplastic components.

### BACKGROUND OF THE INVENTION

Laser welding of thermoplastics typically utilizes diode or Nd:YAG lasers in the near-infrared spectrum, and is accomplished using the through-transmission technique. High intensity infrared laser light passes through a part that is relatively transmissive to light of that wavelength, such as a natural (without added color or filler) polymer, and is absorbed (converted to heat) by material of the second part in the assembly, such as a polymer loaded with carbon black. Various color combinations can be welded, but one must always be relatively transmissive and the other relatively absorbtive at the specific wavelength of laser light used.

Due to the relatively high cost of laser equipment, laser welding has generally only been used where the benefits of clean and precise joints without external heat, vibration, or particulate are requirements of the end use. Since most of the laser welding applications have come from the displacement of other joining technologies, few laser welded assemblies have been designed specifically for laser welding from the initial part concept.

The problem with using assemblies that are not designed specifically for laser welding is that the parts may not be suitable for laser welding. In traditional welding, the assemblies comprise two components, such as the components 12 and 14 shown in FIG. 1. As can be seen the first component 12 includes a substantially planar flange 16 that fits into a groove 18 of the second component. To weld the two components 12, 14 together, the two components are clamped together with the flange 16 projecting into the groove 18, creating a welding surface interface 20. The clamping force is directed perpendicular to the welding surface interface 20. In the embodiment shown in FIG. 1, collapse welding is used, which results in flash or excess material 21 to fill in the rest of the groove 18. However, due to the flow of molten material, the clamping force on the assembly has an influence on the finished part strength and appearance. Too little clamping force will result in weak welds or “skips” in the weld, while too much will result in excessive flash (excess material) or excessive molecular orientation and shear thinning in the joint, leading to reduction in the weld strength.

In contained welding, as illustrated in FIG. 2, flash is eliminated. An assembly designed for traditional welding but converted to contained welding includes two components 22 and 24. As can be seen, the first component 22 includes a substantially planar flange 26 that fits into a groove 28 of the second component 24, creating a welding surface interface 30. Similar to collapse welding, the two components are clamped together, with the direction of the clamping force being perpendicular to the welding surface interface 30. If too little clamping force is used, it can result in weak welds or “skips” in the weld, but one of the advantages of contained welding is that the upper limit of the clamping force is relatively high.

### SUMMARY OF THE INVENTION

According to one embodiment of the present invention, a welding system is provided that includes a pair of thermoplastic components forming a weld interface extending at an acute angle to the direction of application of a clamping force. A clamping mechanism applies a clamping force to the two components to urge the components together at said weld interface, and laser light is directed onto the weld interface to weld the two components together.

In one embodiment of the invention, the interface between the thermoplastic components includes engaging surfaces on the components to prevent sliding movement of the components relative to each other along the weld interface in response to the application of the clamping force. The engaging surfaces are preferably in the shape of registered projections and grooves formed by opposed surfaces of the thermoplastic components. The laser light is preferably directed onto the weld interface in a direction substantially perpendicular to the weld interface, from an exterior surface of at least one of the thermoplastic components that is substantially transparent to the laser light.

The above summary is not intended to represent each embodiment or every aspect of the present invention. The detailed description and accompanying drawings will describe and illustrate certain exemplary embodiments of the present invention.

### BRIEF DESCRIPTION OF THE DRAWINGS

The foregoing and other advantages of the invention will become apparent upon reading the following detailed description and upon reference to the drawings, in which:

FIG. 1 illustrates a laser welding assembly according to the prior art.

FIG. 2 illustrates another laser welding assembly according to the prior art.

FIG. 3 illustrates a laser welding assembly according to one embodiment of the present invention.

FIG. 4 illustrates a laser welding assembly according to another embodiment of the present invention.

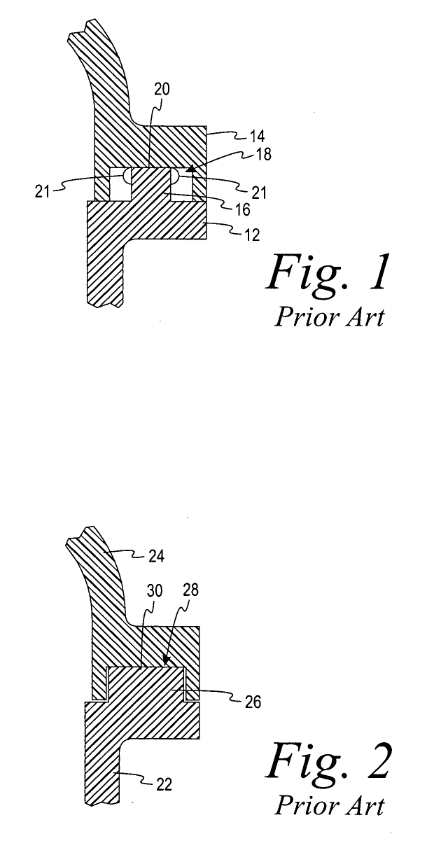

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF ILLUSTRATIVE EMBODIMENTS

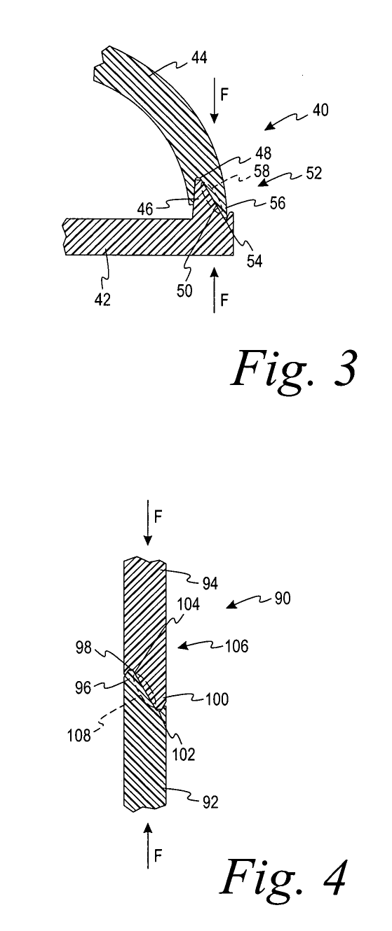

Turning now to FIG. 3, one design of an assembly 40 according to one embodiment of the present invention will be described. In this embodiment, the assembly 40 includes a first thermoplastic component 42 and a second thermoplastic component 44. The two components 42 and 44 fit together at mating surfaces that form a weld interface 50 extending at an acute angle with respect to the direction of application of a clamping force F applied to urge the two components 42, 44 against each other at the weld interface. The weld interface 50 also extends at an acute angle to the outer surfaces of the components being welded.

The mating surfaces of the two components 42, 44 also form engaging portions that prevent sliding movement of the two components 42, 44 relative to each other along the weld interface 50. Thus, in the illustrative embodiment, the first component 42 includes a wedge-like protrusion 46 that fits into a groove 48 in the second component 44, and the first component 42 also includes a groove 54 that is adapted to engage an edge portion 56 of the component 44.

To weld the two components 42, 44 together, the projection 46 is first inserted into the groove 48, and a clamping force is F applied in a vertical direction as viewed in FIG. 3. The mating projections and grooves prevent sliding of the two components relative to each other along the weld interface in response to the clamping force F. Laser light 52 is then directed onto the weld interface 50 to fuse the two components 42, 44 together along the weld interface. The light beam is directed onto the weld interface in a direction generally perpendicular to the weld interface 50, creating a weld zone 58. The laser light is preferably directed onto the weld interface 50 from an exterior surface of at least one of the components 42, 44 that is substantially transparent to the laser light.

The laser may be a diode laser, an Nd:YAG laser, an ultraviolet laser, a visible-light laser, or any other laser suitable for use in welding thermoplastic materials. At least one of the components 42, 44 should be substantially transparent to light generated by the particular laser selected for any given application, while the other component needs to absorbent. The components 42, 44 can be of various color combinations, but one of the components (in this embodiment, the second component 44) should be relatively transmissive and the other (in this embodiment, the first component 42) relatively absorbtive at the specific wavelength of the laser light used. In order to maximize transmissiveness at the welding surface interface 50, the welding surface interface 50 should be glossy. Also, the second component 44 is preferably be made of an amorphous material, which typically transmits laser light efficiently. In embodiments using semi-crystalline materials, the distance from the light entry point to the surface welding interface 50 should be minimized to reduce the loss to scattering of the laser light.

Also, fillers and reinforcements block or scatter laser light. Therefore, in a preferred embodiment, the second component 44 is a neat (unfilled) material. If a material with a filler is used, the thickness should be minimized. If the component material is colored, and the transmission distance is sufficiently long, the laser intensity at the entry surface can result in melting at the entry point rather than at the welding surface interface 50.

In this embodiment, the applied clamping force F is redirected along the angled interface 50 to urge the surfaces into intimate contact while maintaining near-perpendicular light entry and minimal transmission distance. The illustrative assembly 40 eliminates the need for a joint containing a flange. The two components being joined may have any desired three-dimensional shape. For example, the component 42 may be a circular disc having a peripheral rim forming the weld-interface surfaces, and the component 44 may be a circular dome with the lower peripheral edge of the dome forming the weld-interface surfaces.

One laser welding technique suitable for use with this design is simultaneous welding. Simultaneous welding typically uses a multiplicity of optical fibers to deliver light from an array of diode lasers to the joint in the configuration required to illuminate the entire joint simultaneously. This method can deliver very fast cycle times. This system approach allows for considerable freedom in part design. The fibers required to deliver the light result in high tooling costs and long setup times. Balancing of light from the various diode lasers must also be taken into account. This type of welding can also be used in the collapse welding described above.

Another suitable technique is contour welding, which uses a single spot of laser light moving around the assembly, leaving a line of weld behind it much as a pen leaves a line of ink behind as it is moved across a paper. In contour welding, either the part or the beam, or both can be moved. Direct optics, fiber delivery, beam-steering “galvo” systems, or moving fixtures can be employed to direct the beam to the appropriate point. There is theoretically no limit to the part size or configuration that can be welded using this method, so long as the geometry does not make it impossible to get laser light to the joint area. Highly programmable systems can be created that result in short setup times and low dedicated tooling costs.

A modified embodiment of the present invention is shown in FIG. 4. In this embodiment, an assembly 90 includes a first thermoplastic component 92 and a second thermoplastic component 94. The first component 92 includes a protrusion 96 and a mating groove 102, and the second component 94 includes a groove 98 and a mating protrusion 100. The first component 92 is pressed against the second component 94 such that the protrusion 96 fits into the groove 98, and the protrusion 100 fits into the groove 104, creating an S-shaped joint. A weld interface 104 is created and extends at an acute angle to the direction of application of the clamping force F. Laser light 106 is directed onto the weld interface in a direction generally perpendicular to the weld interface 104, creating a weld zone 108. This design allows for the same or even greater design freedom as the embodiment discussed above while also allowing a smaller nominal wall thickness at the joint for the same strength.

While the present invention has been described with reference to one or more particular embodiments, those skilled in the art will recognize that many changes may be made thereto without departing from the spirit and scope of the present invention. Each of these embodiments and obvious variations thereof are contemplated as falling within the spirit and scope of the claimed invention, which is set forth in the following claims.

1. A method of welding two thermoplastic components, comprising
forming a weld interface between the two components to be welded together, said weld interface extending at an acute angle to the direction of application of said clamping force, and
welding said components to each other by directing laser light onto said weld interface while urging the two components against each other at the weld interface by the application of a clamping force.

2. The method of claim 1 wherein the interface between said components includes engaging surfaces on said components to prevent sliding movement of said components relative to each other along said weld interface in response to the application of said clamping force.

3. The method of claim 2 wherein said engaging surfaces include registered projections and grooves formed by opposed surfaces of said components.

4. The method of claim 1 wherein said laser light is directed onto said weld interface in a direction substantially perpendicular to said weld interface.

5. The method of claim 1 wherein said laser light is directed onto said weld interface from an exterior surface of at least one of said components that is substantially transparent to the laser light.

6. A method of welding two thermoplastic components, comprising
forming a weld interface between the two components to be welded together, said weld interface extending at an acute angle to an outer surface of at least one of said components,
forming engaging surfaces on said components to prevent sliding movement of said components relative to each other along said weld interface in response to the application of a clamping force, and
welding said components to each other by directing laser light onto said weld interface while urging the two components against each other at the weld interface by the application of a clamping force.

7. A welding system for welding two thermoplastic components, comprising
a pair of thermoplastic components forming a weld interface extending at an acute angle to the direction of application of a clamping force,
a clamping mechanism applying a clamping force to said components to urge said components together at said weld interface, and
a source of laser light directed onto said weld interface to weld the two components together.

8. The welding system of claim 7 wherein the interface between said components includes engaging surfaces on said components to prevent sliding movement of said components relative to each other along said weld interface in response to the application of said clamping force.

9. The welding system of claim 8 wherein said engaging surfaces include registered projections and grooves formed by opposed surfaces of said components.

10. The welding system of claim 7 wherein said laser light is directed onto said weld interface in a direction substantially perpendicular to said weld interface.

11. The welding system of claim 7 wherein said laser light is directed onto said weld interface from an exterior surface of at least one of said components that is substantially transparent to the laser light.

12. A welding system for welding two thermoplastic components, comprising
a pair of thermoplastic components forming a weld interface extending at an acute angle to an outer surface of at least one of said components,
a clamping mechanism applying a clamping force to said components to urge said components together at said weld interface,
engaging surfaces on said components to prevent sliding movement of said components relative to each other along said weld interface in response to the application of a clamping force, and
a source of laser light directed onto said weld interface to weld the two components together.
